(19) United States
(12) Patent Application Publication
(10) Pub. No.: US 2026/0169298 A1
(43) Pub. Date: Jun. 18, 2026

(54) Smart optical device

(71) Applicant: AAC ACOUSTIC TECHNOLOGIES (SHENZHEN) CO., LTD., Shenzhen (CN)

(72) Inventors: Songtao Li, Shenzhen (CN); Qingshan Xu, Shenzhen (CN); Hongyan Tao, Shenzhen (CN)

(21) Appl. No.: 18/986,572

(22) Filed: Dec. 18, 2024

Related U.S. Application Data
(63) Continuation of application No. PCT/CN2024/120667, filed on Sep. 24, 2024.

(51) Int. Cl. G02B 27/01

(52) U.S. Cl. CPC G02B 27/0176; G02B 2027/0152; G02B 2027/0159; G02B 2027/0163

(57) ABSTRACT

The present invention provides a smart optical device includes a screen, a holder spaced apart from the screen, a driving assembly secured to the holder, a reflector assembly movably connected to the holder, and a prism assembly fixedly connected to the holder. The driving assembly includes a screw located at least partially out of the holder and a slider connected to the screw through a thread. The reflector assembly abuts against the slider. When rotating the screw, the slider moves in a first direction to push the reflector assembly to move in a second direction, the first direction is an axis direction of the screw and the second direction is perpendicular to the first direction. The smart optical device of the present invention has the function of adjusting refractive power by rotating the screw. The smart optical device has a simple structure and is easy to operate.

### FIELD OF THE PRESENT INVENTION

The present invention relates to the field of lens, and more particularly, to a smart optical device.

### DESCRIPTION OF RELATED ART

With the development of technology, smart optical devices such as AR (Augmented Reality) glasses can provide users with virtual text, images, videos, and other contents, while also allowing users to view real-world scenes. At the same time, virtual contents (virtual images) and real-world scenes (real images) can be integrated and interacted to meet users' applications in various fields such as entertainment, consumption, education, social interaction, and industrial production. Smart optical devices with refractive power adjustment function can meet the needs of various myopic users and are increasingly popular among users and market demand.

In related art, the screen providing virtual image is generally arranged in the adjustment structure for adjusting the refractive power, and the effect of adjusting the refractive power is achieved by adjusting the distance between the screen and the reflector assembly. However, in related art, when adjusting the position of the screen, the screen is easy to tilt, which will affect the imaging effect of smart optical devices.

Therefore, it is desired to provide a new smart optical device which can overcome the above problems.

### SUMMARY

In view of the above, the embodiments of the present invention provide a new smart optical device which can stably adjust the refractive power of the smart optical device.

The present invention provides a smart optical device includes a screen, a holder spaced apart from the screen, a driving assembly secured to the holder, a reflector assembly movably connected to the holder, and a prism assembly fixedly connected to the holder. The driving assembly includes a screw located at least partially out of the holder and a slider connected to the screw through a thread. The reflector assembly abuts against the slider. When rotating the screw, the slider moves in a first direction to push the reflector assembly to move in a second direction, the first direction is an axis direction of the screw and the second direction is perpendicular to the first direction.

As an improvement, the reflector assembly is mounted in a receiving space enclosed by the holder and extends at least partially beyond the holder, the reflector assembly including a frame, a compensating mirror fixed to the frame, and a reflector fixed to one side of the compensating mirror proximal to the prism assembly.

As an improvement, the slider includes a first inclined surface, and the frame includes a second inclined surface, the first inclined surface abutting against the second inclined surface and cooperating with the second inclined surface to drive the reflector assembly to move.

As an improvement, the holder includes at least one first limiting structure, and the frame includes at least one second limiting structure, the first limiting structure cooperating with the second limiting structure to limit a movement path of the reflector assembly.

As an improvement, the first limiting structure is a groove, and the second limiting structure is a protrusion located in the groove, or the second limiting structure is a groove, and the first limiting structure is a protrusion located in the groove.

As an improvement, the smart optical device further includes at least one spring sandwiched between the holder and the frame and abutting against the holder and the frame.

As an improvement, the compensating mirror and the reflector are fixed to the frame by adhesive.

As an improvement, the prism assembly includes a fixture frame, a first prism fixed to the fixture frame, and a second prism fixed to the first prism.

As an improvement, a range of a displacement of the reflector assembly is 0-2 millimeters.

As an improvement, a sealing ring is provided between the screw and the holder.

### BRIEF DESCRIPTION OF THE DRAWINGS

Many aspects of the exemplary embodiments can be better understood with reference to the following drawing. The components in the drawing are not necessarily drawn to scale, the emphasis instead being placed upon clearly illustrating the principles of the present invention. Moreover, in the drawings, like reference numerals designate corresponding parts throughout the several views.

FIG. 1 is an illustrative isometric view of a smart optical device in accordance with one embodiment of the present invention.

FIG. 2 is a partially exploded view of some members of the smart optical device of FIG. 1.

FIG. 3 is another partially exploded view of some members of the smart optical device of FIG. 2 from another perspective.

FIG. 4 is one more another partially exploded view of some members of the smart optical device of FIG. 2 from another perspective.

FIG. 5 is an illustrative cross-sectional view of some members of the smart optical device taken along line A-A of FIG. 2.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of the present invention more apparent, the present invention is described in further detail together with the figures and the embodiments. It should be understood the specific embodiments described hereby is only to explain the disclosure, not intended to limit the disclosure.

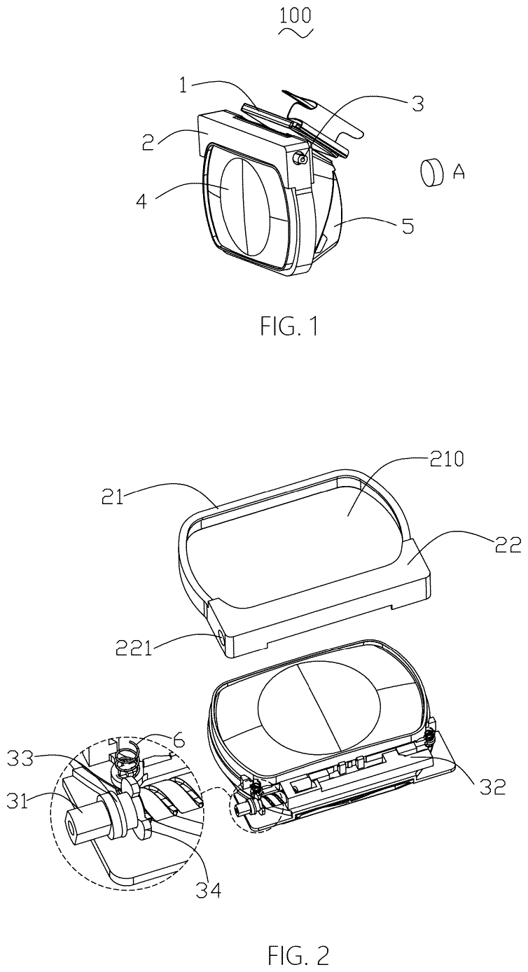

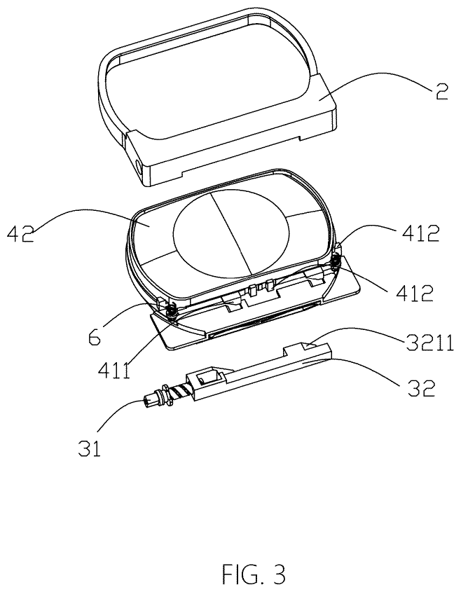

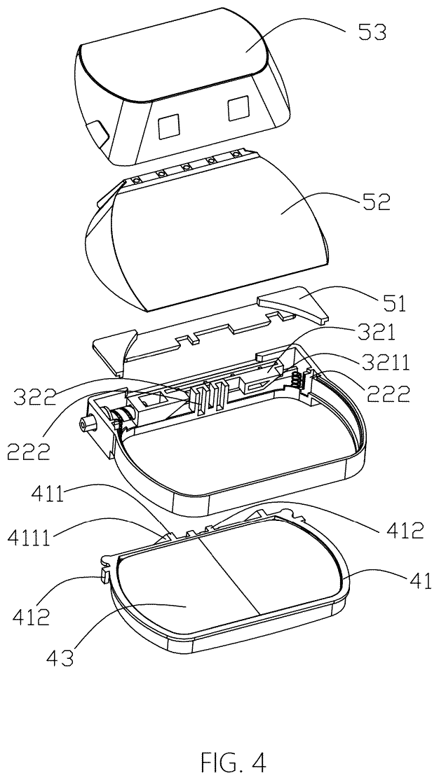

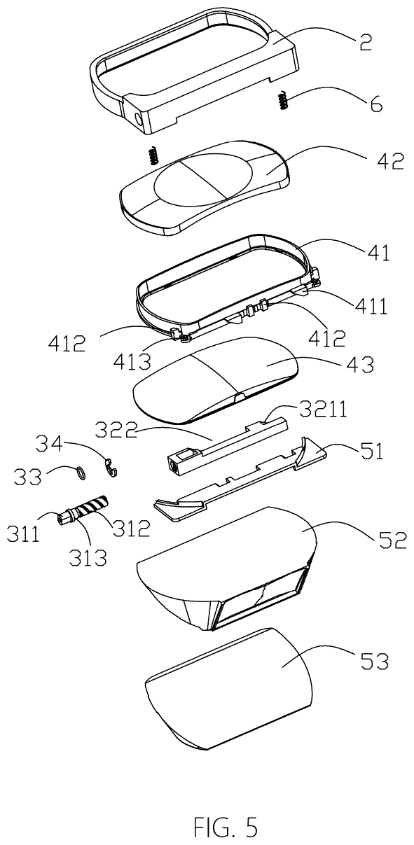

Referring to the FIGS. 1-5, the present invention provides one embodiment of a smart optical device 100. The smart optical device 100 includes a screen 1, a holder 2 spaced apart from the screen 1, a driving assembly 3 secured to the holder 2, a reflector assembly 4 movably connected to the holder 2, and a prism assembly 5 fixedly connected to the holder 2 and at least one spring 6. As shown in FIG. 1, point A is a position of the human eyes.

The smart optical device 100 provided by the present invention is a schematic view of a left eye structure, and the refractive power of the left eye structure can be adjusted manually. In practical applications, the left eye structure and the right eye structure are symmetrically arranged in the same structure. The refractive power of the entire smart glasses can be adjusted by adjusting the left eye structure and the right eye structure separately.

The screen 1 provides a virtual image for the user, and the screen 1 is located out of the holder 2. Specifically, the screen 1 is positioned diagonally above the outer side of the holder 2. The screen 1 is fixed relative to the holder 2. When adjusting the refractive power of the smart optical device 100 of the present invention, the screen 1 will not move, thereby ensuring the stability of an image source.

The holder 2 is a ring-shaped structure as a whole. The holder 2 includes a main body portion 21 enclosing a receiving space 210 and an extension portion 22 located on one side of the main body portion 21. The driving assembly 3 is fixed in the extension portion 22. One end of the extension portion 22 is provided with a through hole 221. The extension portion 22 of the holder 2 includes at least one first limiting structure 222. In this embodiment, the number of the first limiting structures 222 is multiple. Two of the first limiting structures 222 are provided at a middle position of the extension portion 22. One of the first limiting structures 222 is provided at each end of the extension portion 22.

The driving assembly 3 includes a screw 31 located at least partially out of the holder 2, a slider 32 connected to the screw 31 through a thread, a sealing ring 33 fixed to the screw 31, and a circlip 34. The sealing ring 32 is provided between the screw 31 and the holder 2. The screw 31 is received in the extension portion 22 and extends at least partially beyond the holder 2 from the through hole 221. The screw 31 includes a knob portion 311 extending out of the holder 2, a threaded portion 312 connected to the slider 32, and a connecting portion 313 connecting the knob portion 311 and the threaded portion 312. The connecting portion 313 extends radially beyond the knob portion 311 and the threaded portion 312. And the knob portion 311 is the manually rotated part for adjusting the refractive power of the smart optical device 100. The sealing ring 33 and the circlip 34 are both fixed at the position of the threaded portion 312 close to the connecting portion 313.The sealing ring 33 abuts against the connecting portion 313. The sealing ring 33 is arranged between the connecting portion 313 of the screw 31 and the holder 2 to fill a gap between the screw 31 and the holder 2. The circlip 34 is clamped between the threaded portion 312 and the holder 2.

An axis direction of the screw 31 is defined as a first direction, and the direction perpendicular to the first direction is defined as a second direction. The slider 32 abuts against the reflector assembly 4. When rotating the screw 31, the slider 32 moves in the first direction to push the reflector assembly 4 to move in the second direction. The slider 32 includes at least one first protruding portion 321 with a first inclined surface 3211. The number of the first protruding portions 321 are two, and a gap between adjacent protruding portions 321 form an avoidance portion 322 between them. After assembly, some of the first limiting structures 222 are located in the avoidance portion 322. In this embodiment, there are two first limiting structures 222 located within the avoidance portion 322.

A range of a displacement of the reflector assembly 4 is 0-2 millimeters. The reflector assembly 4 is mounted in the receiving space 210 enclosed by the holder 2 and extends at least partially out of the holder 2. The reflector assembly 4 includes a frame 41, a compensating mirror 42 fixed to the frame 41, and a reflector 43 fixed to one side of the compensating mirror 42 proximal to the prism assembly 5. The compensating mirror 42 and the reflector 43 are fixed to the frame 41 by adhesive.

The frame 41 includes at least one second protruding portion 411 with a second inclined surface 4111. The number of the second protruding portions 4111 are two. The first inclined surface 321 abuts against the second inclined surface 411 and cooperating with the second inclined surface 411 to drive the reflector assembly 4 to move along the second direction. The frame 41 includes at least one second limiting structure 412. The number of the second limiting structures 412 is also multiple. The first limiting structure 222 cooperates with the corresponding second limiting structure 412 to limit a movement path of the reflector assembly 4. This ensures that the reflector assembly 4 moves in a straight line without tilting or shifting. In this embodiment, the first limiting structures 222 are a plurality of grooves, and the second limiting structures 412 are a plurality of protrusions located in the corresponding grooves. When the reflector assembly 4 moves, the protrusion slides in the corresponding groove. In other embodiments, the second limiting structures 412 can be a plurality of grooves, and the first limiting structures 222 can be a plurality of protrusions located in the corresponding grooves.

The frame 41 is provided with a plurality of first protrusions 413, and the first protrusion 413 is in a shape of a cross. An inner surface of the extension portion 22 may also be provided with a plurality of second protrusions corresponding to the first protrusions 413, and the second protrusions may also be in the shape of a cross. Of course, the first protrusions 413 can be provided on the surface of the frame 41, or a receiving groove can be provided on the surface of the frame 41, and the first protrusions 413 can be further provided in the receiving groove. Similarly, the second protrusions can also be provided on the surface of the extension portion 22, or a receiving groove can be provided on the surface of the extension portion 22, and the second protrusions can be further provided in the receiving groove.

The prism assembly 5 includes a fixture frame 51, a first prism 52 fixed to the fixture frame 51, and a second prism 53 fixed to the first prism 52. The fixture frame 51 is fixed to the holder 2 by adhesive. Specifically, the fixture frame 51 is fixed to the extension portion 22 of the holder 2. At the same time, in order to ensure better stability, the first prism 52 is further fixed to the holder 2 by adhesive.

The number of the springs 6 is a pair. Each spring 6 is sandwiched between the holder 2 and the frame 41, and each spring 6 abuts against the holder 2 and the frame 41. The springs 6 provide a certain elastic force when the reflector assembly 4 moves, ensuring that the reflector assembly 4 does not shake during the movement. Specifically, the springs 6 are fixed to the second protrusions on the extension portion 22 of the holder 2 and the first protrusions 413 on the frame 41.

The smart optical device 100 of the present invention can provide virtual contents (virtual images) and real-world scenes (real images) at the same time, and the virtual images and real images can be integrated and interacted to meet users'applications in various fields such as entertainment, consumption, education, social interaction, and industrial production. Specifically, the imaging process of the virtual image is as follows: the screen 1 provides an image, and the image passes through the first prism 52, the second prism 53, and the reflector 43 before reaching the human eyes. The real image is directly presented to the human eyes through the compensating mirror 42, the reflector 43, the first prism 52, and the second prism 53. The compensating mirror 42 is used to correct the deformation of the real image.

Comparing with the related art, the present invention provides a smart optical device including a screen, a holder spaced apart from the screen, a driving assembly secured to the holder, a reflector assembly movably connected to the holder, and a prism assembly fixedly connected to the holder. The driving assembly includes a screw located at least partially out of the holder and a slider connected to the screw through a thread. The reflector assembly abuts against the slider. When rotating the screw, the slider moves in a first direction to push the reflector assembly to move in a second direction, the first direction is an axis direction of the screw and the second direction is perpendicular to the first direction. The smart optical device of the present invention has the function of adjusting refractive power by driving the reflector assembly to move through rotating the screw. The structure is simple and the operation is convenient. The present invention avoids the problem of affecting imaging stability caused by the movement of the screen when the screen is driven.

It is to be understood, however, that even though numerous characteristics and advantages of the present exemplary embodiments have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A smart optical device, comprising:
a screen;
a holder spaced apart from the screen;
a driving assembly secured to the holder, the driving assembly comprising a screw located at least partially out of the holder and a slider connected to the screw through a thread;
a reflector assembly movably connected to the holder, the reflector assembly abutting against the slider; and
a prism assembly fixedly connected to the holder;
wherein when rotating the screw, the slider moves in a first direction to push the reflector assembly to move in a second direction, the first direction is an axis direction of the screw and the second direction is perpendicular to the first direction.

2. The smart optical device as described in claim 1, wherein the reflector assembly is mounted in a receiving space enclosed by the holder and extends at least partially beyond the holder, the reflector assembly comprising a frame, a compensating mirror fixed to the frame, and a reflector fixed to one side of the compensating mirror proximal to the prism assembly.

3. The smart optical device as described in claim 2, wherein the slider comprises a first inclined surface, and the frame comprises a second inclined surface, the first inclined surface abutting against the second inclined surface and cooperating with the second inclined surface to drive the reflector assembly to move.

4. The smart optical device as described in claim 2, wherein the holder comprises at least one first limiting structure, and the frame comprises at least one second limiting structure, the first limiting structure cooperating with the second limiting structure to limit a movement path of the reflector assembly.

5. The smart optical device as described in claim 4, wherein the first limiting structure is a groove, and the second limiting structure is a protrusion located in the groove, or the second limiting structure is a groove, and the first limiting structure is a protrusion located in the groove.

6. The smart optical device as described in claim 2, wherein the smart optical device further comprises at least one spring sandwiched between the holder and the frame and abutting against the holder and the frame.

7. The smart optical device as described in claim 2, wherein the compensating mirror and the reflector are fixed to the frame by adhesive.

8. The smart optical device as described in claim 1, wherein the prism assembly comprises a fixture frame, a first prism fixed to the fixture frame, and a second prism fixed to the first prism.

9. The smart optical device as described in claim 1, wherein a range of a displacement of the reflector assembly is 0-2 millimeters.

10. The smart optical device as described in claim 1, wherein a sealing ring is provided between the screw and the holder.
